(19) United States
(12) Patent Application Publication
(10) Pub. No.: US 2019/0079943 A1
(43) Pub. Date: Mar. 14, 2019

(54) REAL TIME AND RETROSPECTIVE QUERY INTEGRATION

(71) Applicant: Blackfynn Inc., Philadelphia, PA (US)

(72) Inventors: Jim Snavely, Philadelphia, PA (US); Joost B.M. Wagenaar, Philadelphia, PA (US)

(21) Appl. No.: 16/126,457

(22) Filed: Sep. 10, 2018

Related U.S. Application Data
(63) Continuation of application No. 62/557,011, filed on Sep. 11, 2017.

(51) Int. Cl. G06F 17/30

(52) U.S. Cl. CPC G06F 17/30091

(57) ABSTRACT

This application relates to a data storage infrastructure for high volume data streams, for example, sensor data from medical monitoring systems. In some implementations, an initial database is time indexed (e.g., each datum includes a timestamp as part of the row key) and can be queryable in real time as data is ingested. The data storage infrastructure can include an initial database as a short term queryable storage as data is streamed to the data storage infrastructure which can be used to correctly sequence incoming data streams. The data storage infrastructure can include a second, long term, storage for the received data. This long term database is configured to receive and store data from the initial database. The combination of the initial database and the long term database forms a hybrid data storage infrastructure combining benefits of the both the initial and long term databases.

### CROSS REFERENCE TO RELATED APPLICATIONS

This application claims the benefit of U.S. Provisional Application No. 62/557,011, titled “Real Time and Retrospective Query Integration” filed Sep. 11, 2017, which is incorporated by reference in its entirety.

### FIELD OF ART

This disclosure generally relates to a data storage infrastructure operating on a computer or computer network, and particularly to a data storage infrastructure for ingesting high volume data streams from a wide variety of devices.

### BACKGROUND

Across many industries, sensors or other devices report data in the form of high volume data streams, sending data either continuously or based on a sensor detecting a certain event. For example, many medical devices include sensors which report data streams to a server for storage and later access. Servers receiving these data streams can therefore be required to handle high volumes of unordered data and provide an interface to query and return that data on request. Therefore, there is a need for a specialized data storage infrastructure for storing and ordering data from high volume data streams.

### SUMMARY

In various embodiments, a data storage infrastructure comprises a first database storing a plurality of data entries, where each data entry includes a key comprising a channel identifier of a reporting device and a timestamp associated with sensor data reported for that timestamp along with a value of the sensor data reported by the reporting device. The data storage infrastructure further includes a second database comprising a file storage database storing a plurality of files and a storage index. Each file of the file storage database can include data entries comprising a channel identifier of a reporting device, a timestamp, and sensor data reported by the reporting device. The storage index can include a table with a channel identifier column indicating the channel identifier for each row, a time range column indicating a range of timestamps associated with each row, an address column indicating an address of a file in the file storage database associated with each row. Entries in the storage index can relates to one of the files in the file storage database. The data storage infrastructure further includes a control logic layer configured to select a subset of data entries of the first database, create a corresponding row in the storage index and a file in the file storage database, and remove the selected data entries from the first database.

In one or more embodiments, the first database is a time series database configured to order received data entries.

In one or more embodiments, selecting a subset of data entries of the first database includes selecting a data block associated with a timestamp range including the selected data entries.

In one or more embodiments, selecting the data block includes determining if the data block is complete based on a threshold time passing from the associated timestamp range.

In one or more embodiments, the created file in the file storage database includes the subset of data entries and the created row in the storage index contains the timestamp range of the data block and the location of the data block within the file storage database.

In one or more embodiments, the control logic layer is further receives a request for data entries associated with a requested timestamp range, retrieves related data entries the first database and a data block from the second database, and combines the retrieved data entries from the first and second databases into a requested subset of data entries which is returned to the requesting device.

In one or more embodiments, combining the retrieved data entries from the first and second databases includes resampling the retrieved data entries to a target sampling frequency.

In various embodiments, methods, computer readable storage mediums, and systems described herein include receiving an out of order data stream of data entries from a reporting device, where each data has a channel identifier, a timestamp, and sensor data associated with the timestamp. The received data entries can then be stored in a first database as they are received at the data storage infrastructure, where the first database orders the data entries as they are stored. A data block for a certain timestamp range can then be selected from the stored data entries in the first database, transferred to a file in a file storage database, and indexed in the storage index by channel identifier and timestamp range. Similarly, the corresponding data entries in the first database can be deleted.

In one or more embodiments, the first database is a time series database using a key value structure.

In one or more embodiments, the row key for each data entry in the first database includes the timestamp and channel identifier of the data entry.

In one or more embodiments, selecting a data block of data entries associated with a timestamp range comprises determining if the data block is complete based on a threshold time passing.

In one or more embodiments, the method includes receiving a request for data associated with a timestamp range from a device, retrieving and combining data entries from the requested range from the databases, and returning the requested data entries to the requesting device.

In one or more embodiments, retrieving data entries within the requested timestamp range includes querying the storage index for a data block associated with the requested timestamp range, retrieving the data block from the file storage database and selecting one or more data entries associated with the requested timestamp range from the data block.

In one or more embodiments, combining the retrieved data entries from the first and second databases includes resampling the retrieved data entries to a target sampling frequency.

### BRIEF DESCRIPTION OF THE DRAWINGS

FIG. 1 illustrates an example computing environment for the data storage infrastructure, according to an example embodiment.

FIG. 2 is a block diagram illustrating an example embodiment of storing data from a reporting device in a long term database.

FIG. 3 is a flowchart illustrating an example process for receiving and storing data in a data storage infrastructure.

FIG. 4 is a block diagram illustrating an example embodiment of responding to a query for data from a querying system.

FIG. 5 illustrates a process for resampling continuous data, according to an example embodiment.

FIG. 6 illustrates a process for resampling a unit data set, according to an example embodiment.

FIG. 7 is an interaction diagram illustrating an example process for responding to a received query for data.

The figures depict various embodiments of the present invention for purposes of illustration only. One skilled in the art will readily recognize that alternative embodiments of the structures and methods illustrated herein may be employed without departing from the principles of the invention described herein.

### DETAILED DESCRIPTION

### I. Overview

This application relates to a data storage infrastructure operating on a computer or computer network, and particularly relates to a data storage infrastructure for transforming high volume data streams ingested from a wide variety of devices over such a network into queryable data. In particular use cases, the data is sensor data from medical monitoring systems such as in-hospital devices, wearable devices, and implanted medical devices. For example, medical monitoring devices can assess vital signs or other aspects of patient status or condition, for example providing heart information, EKG information, fluid levels, or any other type of real-time output or stochastically generated data.

The data storage infrastructure allows for 1) ingested data to be queryable substantially in real time, for example ingested data may be queryable within 1-2 seconds after it is ingested, and 2) for large volumes of data to be stored in a compressed format to both save storage space and also allow for querying at some later date.

The data storage infrastructure includes at least two data storage systems. In some implementations, an initial database is time indexed (e.g., each datum includes a timestamp as part of the row key) and can be queryable in real time as data is ingested. The initial database acts as a short term queryable storage as data is streamed to the data storage infrastructure by one or more reporting devices. An example of the initial database is a key value store, for example a HBASE time series database (https://en.wikipedia.org/wiki/Apache_HBase). The initial database can be configured to scale well depending upon the load of incoming data streams from external computing devices. For example, HBASE is a distributed database that makes more nodes available as needed. Further, the initial database can be used to correctly sequence incoming data streams. HBASE particularly is natively designed to time sequence inbound data automatically.

The data storage infrastructure may store any desired additional metadata with the time-indexed data in addition to the actual data itself. For example, metadata may include entity identification information (e.g., user, patient, provider ID), the type or specific ID number of the sensor device providing the data, the georeferenced location of the device providing the data at the time it provided the data, and/or any other sort of data maintained by the data storage infrastructure that might be relevant for inclusion and storage.

The data storage infrastructure can further include a second data storage system communicatively coupled to the initial database. In some implementations, the second data storage system acts as a long term queryable storage for the received data. This long term database is configured to batch pull (or otherwise receive) data from the initial database to be stored in the long term database. The data pulled from the initial database can then be deleted therefrom to keep the initial database at a manageable size. Data stored in the long term database may be compressed for long term storage, for example using GZIP or any other suitable compression technique. Data from the initial database may be pulled simply by querying the initial database, where the initial database is responding as it would to any other query for data. Alternatively, the data transfer between the initial and long term databases may occur according to some other process. The combination of the initial database and the long term database forms a hybrid data storage infrastructure combining benefits of the both the initial and long term databases.

In some implementations, the key structure of the initial database and the long term database is configured to ensure that query access to both the initial database and the long term database remains responsive even in situations where there is a burdensome amount of data in the initial database and/or the long term database or where there is a significant rate of ingestion that would affect database performance. In one embodiment, the range of values used for a timestamp-based key in the initial database is a custom range that is based on the combination of a timestamp and a device ID (for example of the sensor capturing the data stream). Using custom ranges based on device ID is useful at least in part because it allows a separate querying computing entity to pull all device data from a specific device by omitting the timestamp (e.g., such as in the pulls done by the long term database where often a significant amount of data may have been collected over the course of a/an hour, day, week, month, year, or period of years), or over specific time ranges by specifying individual timestamps or timestamp ranges. Specifying a specific timestamp or timestamp range in query or other data retrieval significantly narrows the search space within the data storage infrastructure, allowing for rapid pulls without a significant amount of processing time or processing power required by the computing devices providing and/or interacting with the data storage infrastructure.

In some embodiments, the data arriving at the initial database is somewhat uniform in data size, for example when receiving a data stream of sensor data from a set of sensors. Generally, sensor type data is 8-32 bytes per datum. For example, the received data may be floating point values with timestamps or other similarly short-form data. In some implementations, the data received by the initial database is similar across the different providers of data of a given type. For example, across different sensors providing the same type of data. More specifically, monitoring sensors of a given type will in general provide data in the same format, and generally the provided data will be of short-form to make regular reporting to the initial database efficient.

Additionally, sensor data (or any other suitable data) can be received in a suitable file format to be stored in the data storage infrastructure. Sensor data or other suitable timeseries data can be received in a suitable format that can represent a series of sampled values. For example, data can be received in a proprietary binary or delimited text format, a timeseries file format (such as .mef, .mefd.gz, .edf, .tdms, .lay, .dat, or .nex), or any other suitable file format (such as .e, .continuous, .spikes, .events, .nev, .nsl, ,settings, ,data, ,index, .mat, or .m).

Both continuous and unit sensor data can be received by the data storage infrastructure. Continuous data is captured by the sensor or other reporting device at regular intervals and provides continuous stream of information on the measured parameter based on the sampling frequency of the continuous data. In contrast, unit data can report an event each time a triggering condition is met (for example, each time a specific event is captured by the sensor). Such data is associated with a timestamp of the event as it is captured to a level of precision based on the resolution of the unit data.

### II. Computing Environment Overview

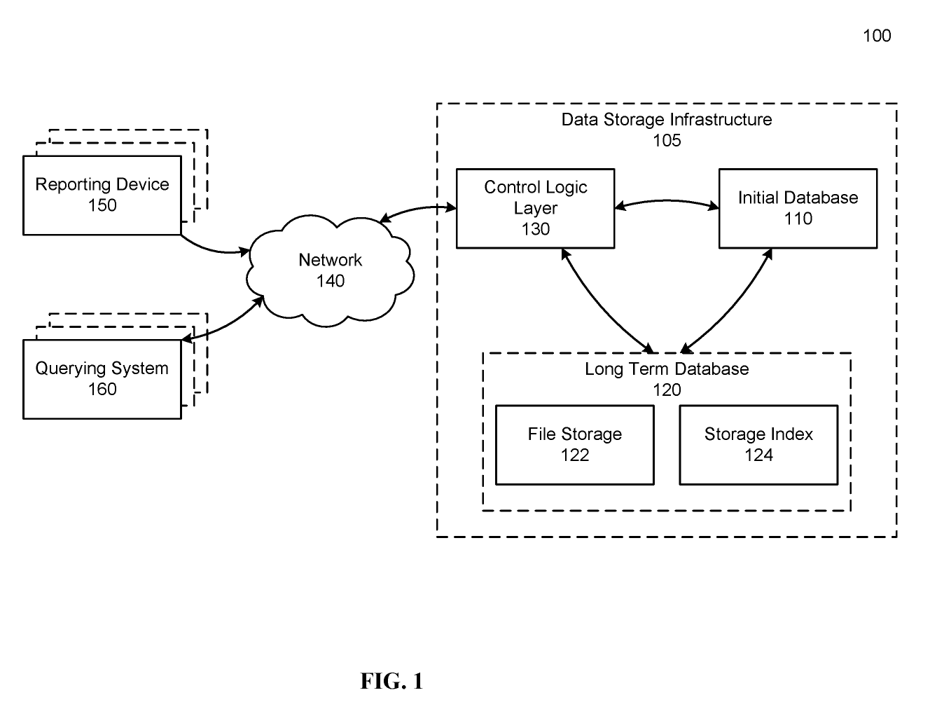

FIG. 1 illustrates an example computing environment for the data storage infrastructure, according to one embodiment. The environment 100 of FIG. 1 includes a data storage infrastructure 105 comprising the initial 110 and long term 120 databases and a control logic layer 130. The environment 100 additionally includes a network 140 connecting the data storage infrastructure 105 to reporting devices 150 and querying systems 160.

The data storage infrastructure 105 itself may comprise one or more computing devices or virtual machines instances spread over a variety of machines, or any other combination of physical or virtual software instances designed to support the operation of the databases. The data storage infrastructure 105 also includes any physical computing and software logic needed to support the operations herein (for example, the control logic layer 130).

As one example, the data storage infrastructure 105 may be implemented as one or more server-class computing systems that uses powerful processors, large memory, and faster network components compared to a typical computing system used, for example, as a reporting device 150 or querying system 160. Such a server typically has large non-transitory storage medium, for example, using a RAID (redundant array of independent disks) array and/or by establishing a relationship with an independent content delivery network (CDN) contracted to implement the initial 110 and long term 120 databases. Additionally, such a computing system generally includes an operating system, for example, a UNIX operating system, LINUX operating system, or a WINDOWS operating system. The operating system manages the hardware and software resources of the server and also provides various services, for example, process management, input/output of data, management of peripheral devices, and so on.

The control logic layer 130 (or simply control logic 130) generally operates on top of an operating system and includes instructions to ingest data, perform CRUD (create read update delete) operations, respond to queries for data, and carry out any other operations described herein. The control logic 130 receives data ingested from the reporting devices 150 and, in some embodiments, routes the data to the initial database 110 for storage. The control logic 130 further receives and responds to queries from querying systems 160 for data from the data storage infrastructure 105 (for example stored in the initial 110 and/or long term 120 databases). For example, the control logic 130 can request the appropriate data from the initial 110 and long term 120 databases, resample the retrieved data to match the query, combine the data received from the initial and long term databases, and return the requested data to the querying system 160. In some implementations the control logic 130 schedules data for transfer out of the initial database 110 into the long term database 120 for long term storage and compression.

The initial 110 and long term 120 databases store data reported from the reporting devices 150. Although any kind of data may be stored in the data storage infrastructure 105, in some implementations the reported data includes sensor data from medical or health monitoring devices and optionally related data such as patient and health care provider information, patient medical histories and records, and other similar data. Within the initial and long term databases 110 and 120, any such data may be encrypted pre-transmission from the reporting system 150 or post-ingestion by the databases for security and is at least password protected and otherwise secured to meet all Health Insurance Portability and Accountability Act (HIPAA) requirements. Any analyses that incorporate data from multiple reporting devices 150 can be de-identified as needed such that personally identifying information contained within the data is removed to protect patient privacy. Similar protections may further be implemented to further secure the data stored in the initial 110 and long term 120 databases.

The initial database 110 can be a time series database configured to receive and sequence data from incoming data streams, for example from a reporting device 150. However, the initial database 110 can be prohibitively complex and/or expensive to maintain past a reasonable size, for example requiring specialized server hardware or prohibitively large amounts of computing resources to maintain. Therefore, the data storage infrastructure 105 can transfer data to the long term database 120 for more permanent storage. In some implementations, the long term database 120 stores ordered and complete data already ingested (and in some implementations, ordered by time or otherwise) by the initial database 110. The long term database 120 can incorporate additional compression of stored data and also store data using more economical infrastructure.

The long term database 120 can be implemented using a file-based storage system in conjunction with a separate index database. For example, the long term database 120 of FIG. 1 comprises the file storage 122 and the storage index 124. As data is transferred to the long term database 120 from the initial database 110 the transferred data can be separated into blocks and the blocks of data can be stored in files in the file storage 122. Similarly, the control logic layer 130 can generate and store an index of what data is located in each transferred block (and the corresponding file) in the storage index 124. For example, the file storage 122 can be a local or cloud based file storage system (such as Amazon's™ S3 or a local server). In some embodiments, the storage index 124 can be a database such as PostgreSQL or any other suitable database system.

The data storage infrastructure 105 is communicatively coupled to a network 140. Network 140 uses standard Internet communications technologies and/or protocols. Thus, the network 140 can include links using technologies such as Ethernet, IEEE 802.11, integrated services digital network (ISDN), asynchronous transfer mode (ATM), etc. Similarly, the networking protocols used on the network 140 can include the transmission control protocol/Internet protocol (TCP/IP), the hypertext transport protocol (HTTP), the simple mail transfer protocol (SMTP), the file transfer protocol (FTP), etc. The data exchanged over the network 140 can be represented using technologies and/or formats including the hypertext markup language (HTML), the extensible markup language (XML), etc. In addition, all or some links can be encrypted using conventional encryption technologies such as the secure sockets layer (SSL), Secure HTTP (HTTPS) and/or virtual private networks (VPNs). In another embodiment, the entities can use custom and/or dedicated data communications technologies instead of, or in addition to, the ones described above.

Reporting devices 150 can send data over the network 140 to the data storage infrastructure 105 for ingestion. For example, one or more reporting devices 150 communicate over the network 140 using a network adapter and either a wired or wireless communication protocol. A variety of types of networking adapters and communications protocols may be used, examples of which include long distance protocols such as CDMA, 3G, and LTE/4G, as well as shorter range communications protocols such as WiFi/802.11 and BLUETOOTH/BLUETOOTH Low Energy (BTLE). Wired connections such as Ethernet, co-axial cable, and optical fibers may also be used. Reporting devices 150 may be individual/independent computing devices such as heart rate monitoring machines that are located in hospital, and may also include mobile computing devices paired with health monitoring computing devices that perform particular sensor/monitoring functions. Reporting device 150 can report both continuous and unit data streams to the data storage infrastructure 105. A channel ID (or other suitable device ID) may be assigned to each reporting device 150, data stream, or reporting device 105—infrastructure (pair) connection to distinguish the reporting device 150 or data from a particular sensor on the reporting device 150. For example, a channel ID can be a unique media access control (MAC) address, or any other suitable type of identifier.

Querying systems 160 query the data storage infrastructure 105 over the network 140 to pull data for analysis, display to a user, or any other suitable purpose. In some implementations, the querying systems 160 may use an application programming interface (API) exposed by the data storage infrastructure 105 or the initial 110 and/or long term 120 databases for this purpose. A querying system 160 can request any suitable data or range of data from the data storage infrastructure 105. For example, a query can comprise a request for data associated with a specific channel ID or set of channel IDs over a specified time range. In some implementations, a query requests data at a specified “outbound” sampling frequency (or with another specific level of detail) which may be the same or different from the “inbound” sampling frequency or granularity of the data stored received from reporting devices 150 and/or as stored in the data storage infrastructure 105. Querying systems 160 can be health care provider or patient-associated computing devices. In some cases, a querying system 160 is also a reporting device 150 and may both send data to the data storage infrastructure and request data for display or analysis.

Generally, the reporting devices 150, querying system 160, devices that make up network 140, and data storage infrastructure 105 are all computing devices. The following brief description illustrates common components of a computing device. Generally, computing devices include chipset coupled to at least one processor. Coupled to the chipset is volatile memory, a network adapter, an input/output (I/O) device(s), a storage device representing a non-volatile memory, and a display. In one embodiment, the functionality of the chipset is provided by a memory controller and an I/O controller. In another embodiment, the memory is coupled directly to the processor instead of the chipset. In some embodiments, memory includes high-speed random access memory (RAM), such as DRAM, SRAM, DDR RAM or other random access solid state memory devices.

The storage device is any non-transitory computer-readable storage medium, such as a hard drive or a solid-state memory device. The memory holds instructions and data used by the processor. The I/O device may be a touch input surface (capacitive or otherwise), a mouse, or other type of pointing device, a keyboard, or another form of input device. The display displays images and other information from for the computing device. The network adapter couples the computing device to the network.

As is known in the art, a computing device can have different and/or other components than those mentioned above. In addition, the computing device can lack certain illustrated components. As an example, a computing device acting as server may lack a dedicated I/O device, and/or display. Moreover, the storage device can be local and/or remote from the server (such as embodied within a storage area network (SAN)). In one embodiment, the processing power of the data storage infrastructure 105 is provided by a service such as Amazon Web Services™.

Generally, the exact physical components used in a reporting device 150 will vary in size, power requirements, and performance from those used in the data storage infrastructure 105. For example, reporting devices 150 will include relatively small storage capacities and processing power, but will often include input devices and displays. These components are suitable for user input of data and receipt, display, and interaction with that data.

As is known in the art, a computing device is adapted to execute computer program modules for providing functionality described herein. A module can be implemented in hardware, firmware, and/or software. In one embodiment, program modules are stored on the storage device, loaded into the memory, and executed by the processor.

### III. Data Storage

In order to make data available for querying immediately upon ingestion, a data storage infrastructure 105 as introduced above can be used.

In one example embodiment, the initial database 110 can be implemented with Hbase or another suitable time series database for immediate ingestion and ordering of incoming data. The use of a time series database such as Hbase can make received data available for querying as soon as possible. In this example embodiment, the initial database 110 is particularly configured to automatically order incoming data, for example by using a timestamp of each data entry as part of the row key for the data entry.

For storage and rapid access of a high volume streamed data, it is possible to use a time series database (such as Hbase or InfluxDB) to both ingest and to permanently store the incoming sensor data (hereinafter a “time series only” implementation). While, as described above, a time series only implementation is able to receive, order, and store incoming streams of data (such as streams of sensor data from one or more reporting devices 150), a time series only implementation is impractical and expensive to scale to store large volumes of data permanently. For example, a time series database may require specialized and expensive storage solutions (such as customized and expensive server architecture) to function. Further, a time series only implementation has inherent limitations on the maximum volume of data storable in the database (for example, due to degrading query/access performance as the size of the database increases). In a time series only implementation, the time series database will continuously be fed new data for permanent storage and may quickly (depending on the rate of incoming data) need to be scaled to accommodate extremely large data volumes. Therefore, a time series only implementation may be impractical to scale, due to both cost and technical limitations.

Alternatively, again for storage and rapid access of a high volume streamed data, a file based storage system can be used to both ingest and to permanently store the incoming sensor data (hereinafter, a “file storage only” implementation). A file storage system, in some embodiments, operates by storing ordered blocks of data in files (for example in Amazon's™ S3 system). Thus, a file storage only implementation may operate ingesting data directly from the input data streams into one or more files. Where incoming data streams are assumed to be complete and in order, the data can be successfully stored directly to files. However, reporting devices 150 can often have unreliable or intermittent connections to the network 140. Therefore, each incoming data stream may arrive somewhat out of order and/or with gaps based on inconsistencies in the network connection (for example, dropped or delayed packets). In order to modify data stored data in a file, large portions of the file must be overwritten in many cases. Consequently, it can be impractical to write certain data (such as time series data) to files without the data to be stored being in order and complete (to avoid having to overwrite the file multiple times to reflect newly received data). Therefore, ingesting out of order data into a file storage only implementation can be impractical.

To address these problems, the data storage infrastructure 105 uses an initial database 110 to initially receive and order the incoming data paired with a long term database 120 for permanent storage of the ordered data. In order to keep the size of the, for example, Hbase initial database 110 within a reasonable limit, data can be pulled from the initial database 110 to the long term database 120 as described above. In some embodiments, the long term database comprises a cheap and reliable high capacity file storage 122 (such as Amazon's™ S3 system) paired with a database indexing the data of the file storage 122 (the storage index 124), for example implemented using a PostgreSQL database structure.

As introduced above, the file storage 122 can store files comprising blocks of consecutive data associated with one or more channel IDs which are indexed by database entries in the storage index 124. For example, entries in the storage index 124 can associate each file in the file storage 122 with the rowkey range (in some embodiments, using the same format as the rowkeys of the initial database 110) of the data stored within that file. In order to provide fast access to the data in the file storage 122, a custom range index, for example using PostgreSQL's “range” data type, can be used to index which data is stored in each file of the file storage 122. For example, an entry in the storage index 124 can include an address (or other identifier) of the file within the file storage 122. In some implementations, the file storage 122 can include a caching system to improve performance when retrieving data, for example implemented using Cloudfront™ to cache files stored using the S3 system for quicker retrieval.

III.A. Example Data Storage Process

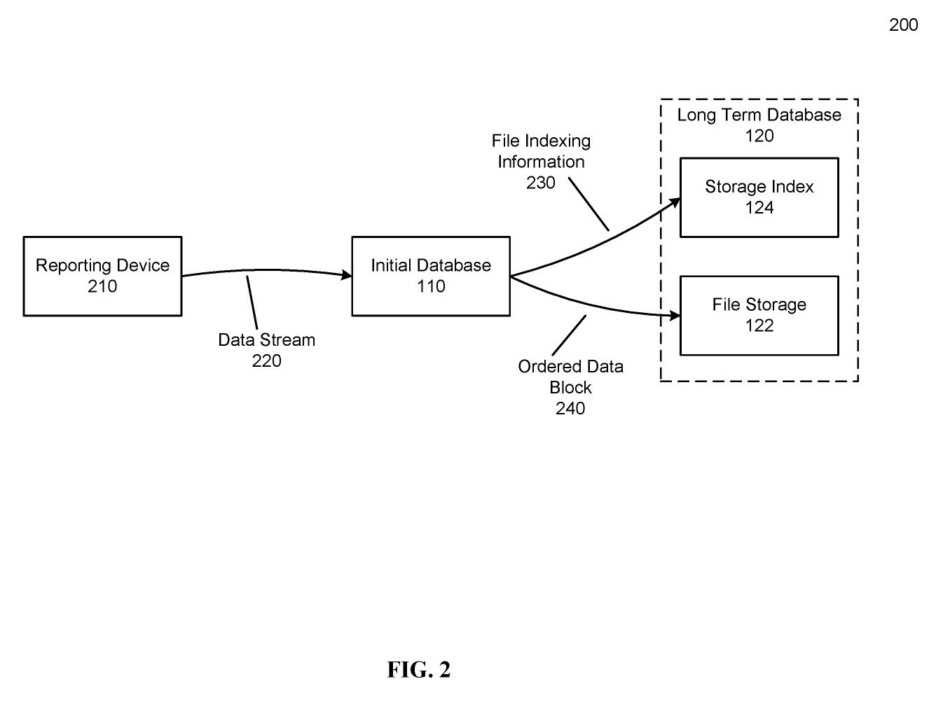

FIG. 2 illustrates an example embodiment of storing data from a reporting device in a long term database. In the embodiment of FIG. 2, a reporting device 210 reports a data stream 220 of data to the data storage infrastructure 105. The control logic 130 routes the data stream 220 to the initial database 110 to be ingested. The data stream 220 may arrive at the initial database 110 out of order, for example due to network communication errors such as dropped and retransmitted packets. The control logic 130 orders the inbound data and stores it in the initial database 110.

The initial database 110 is structured so as to organize individual data entries based on a particular rowkey structure. Specifically, the rowkey structure is of a form including at least a timestamp of that data entry and the channel ID of the reporting device 210. Forming the rowkey in this manner facilitates automatically ordering information for storage in the initial database 110, even if individual datum arrived out of order.

After a given block of data is determined to be complete the control logic 130 can schedule the transfer of that block of data to the long term database 120. Data can be organized into blocks by channel ID and timestamp, for example each block can represent 30 seconds of data from a given channel ID, or each block can represent a given amount of entries (ex. 5000) from a given channel ID. In some implementations, blocks contain data associated from several channel IDs, for example organized by timestamp. The control logic 130 can determine that a block is complete based on any suitable factor or factors, for example, a threshold amount of time passing, or a threshold amount of data entries received for the block. Complete blocks of data can then be transferred (or scheduled for transfer) from the initial database 110 to the long term database 120. In this case, the ordered data block 240 (comprising a set of data entries) is transferred to the file storage 122 to be stored in a file for later retrieval. File indexing information 230 about the contents of the data block and the location of the file in which it is stored is then generated (for example by the control logic 130) and stored in the storage index 124. After the ordered data block 240 is stored in the long term database 120, the copy of the transferred data stored in the initial database 110 can then be deleted (or marked for deletion) from the initial database 110. In some embodiments, the transferred data is immediately deleted from the initial database 110 to maintain only one copy of each data entry/data block between the initial database 110 and the long term database 120.

III.B. Example Data Storage Flowchart

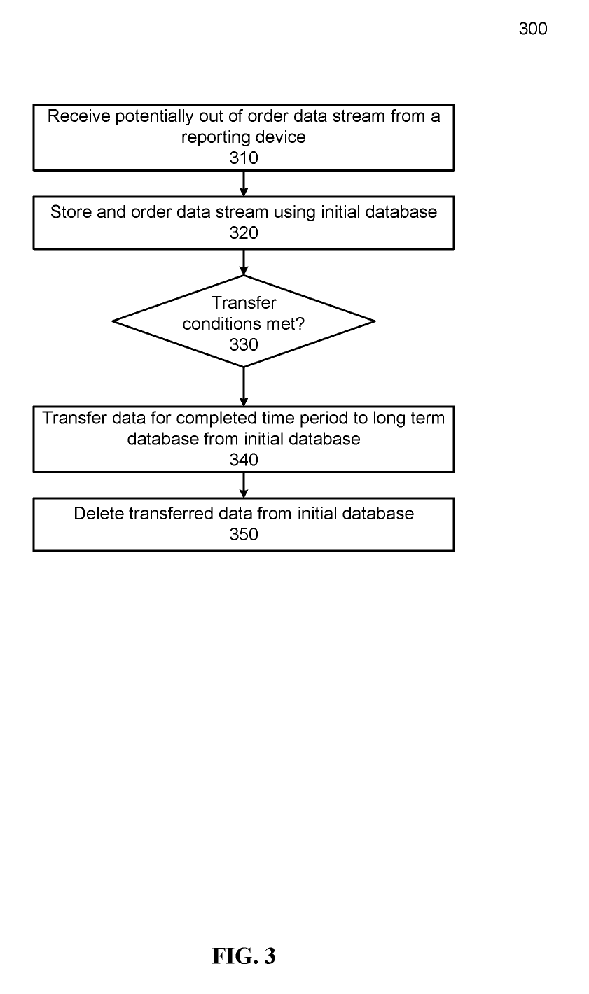

FIG. 3 is a flowchart illustrating an example process for receiving and storing data in a data storage infrastructure. The process 300 begins when a potentially out of order data stream is received 310 at the data storage infrastructure from a reporting device. The received data stream is then stored and ordered 320 using the initial database. Once transfer conditions for a block of the received data are met 330, the data for the completed block (for example a time period of data) is transferred 340 to the long term database from the initial database and subsequently deleted 350 from the initial database.

### IV. Query Response

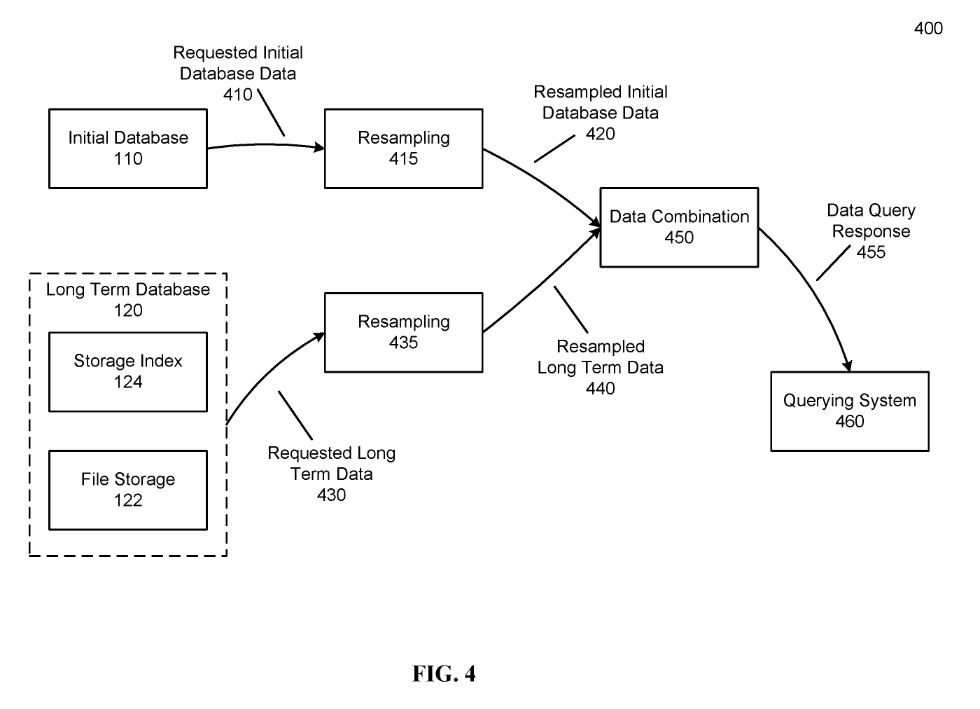

FIG. 4 is a block diagram illustrating an example embodiment of responding to a query for data from a querying system. As described above, a query from a querying system 160 can comprise a request for data stored in the data storage infrastructure 105 associated with a specific channel ID or set of channel IDs over a specified time range. Similarly, a query may be associated with a specific outbound resolution or sampling frequency which may differ from the inbound resolution of the data stored in the data storage infrastructure 105. For example, a query from an external querying system 460 may be obtaining the information for display on a screen capable of displaying the received data at a resolution of 60 samples/second, whereas the requested data is stored at a resolution of 100 samples/second. The target resolution or sampling rate for a query can be specified in the query, calculated by the control logic based on other information about the query or about the querying device 160, or determined by any other suitable method.

To respond to a data query for a given time range the control logic 130 can first request data in the time range from both the initial 110 and long term 120 databases. For example, data can be requested for the channel IDs specified in the data query. The initial 110 and long term 120 databases can then return any stored data for the requested time range, in this embodiment the requested initial database data 410 and the requested long term data 430. According to some embodiments, the control logic 130 requests data for the full time range of the query from both initial 110 and long term 120 databases and any relevant data is returned from either database. In some implementations, a database may return additional data outside the requested range. For example, the long term database may, in some implementations, return data about an entire block of data when the requested time range overlaps with that block. In these implementations, the excess data is discarded prior to sending the response to the query, for example the excess data outside of the request time range can be ignored during the resampling process and therefore not reflected in the final query response.

In some cases, the returned data 410 and 430 from each database 110 and 120 will be at a different resolution or frequency than that required by the query. For example, the data stored in the data storage infrastructure 105 can be stored at a much higher resolution than the resolution requested by the received query. For example, data from a highly sensitive sensor may be a continuous stream of data stored at a resolution of 500 Hz (each data point would represent 2 milliseconds) however, a query requesting data from the sensor may only request data at a resolution of 10 Hz (each data point representing a tenth of a second). Therefore, the requested initial database data 410 and requested long term data 430 can be resampled to the correct resolution/sampling rate for the received query. As used herein, resampling a set of data points yields a resampled set of data points matching the requested resolution or sampling frequency of the received query, where each resampled data point is associated with a time range corresponding the requested resolution or sampling frequency, and where the value of the resampled point can be generated based on the original data points falling within the associated time range. For example, resampling can include downsampling higher sampling frequency data stored in the data storage infrastructure 105 to a lower frequency requested in a query. Thus, each resampled data point can be associated with a resampled value comprising an average or median value of multiple original data points stored in the data storage infrastructure. In some embodiments, returned data is not upsampled and is returned at the original resolution in response to a query requesting data at a higher resolution than the data stored in the data storage infrastructure 105. However, in other embodiments, requested data can be upsampled by techniques such as interpolation between multiple original data points. Although only two example techniques have been provided here, in practice any known technique for upsampling or downsampling can be used to arrive at the sampling rate requested in the query. The process of resampling will be discussed in further detail below.

In the embodiment of FIG. 4, the requested initial database data 410 and the requested long term data are each resampled 415 and 435 separately. Resampling can be performed at the initial 110 and long term 120 databases, at a separate resampling module, by the control logic 130, or by any other suitable method. Similarly, in other embodiments, the requested data from the initial 110 and long term 120 databases are combined before being resampled. The resampled initial database data 420 and the resampled long term data 440 are then combined 450 into a single response to the received query. The resampled initial 420 and long term 440 data can combined by concatenation (for example by assuming the data stored in the initial database is more recent than data stored in the long term storage), based on timestamp, or by any other suitable method. In some embodiments, it is assumed that there are no overlaps in data between the data in the initial 110 and long term 120 databases. That is, it is assumed that each data entry exists in one of the initial database 110 and the long term 120, but not both simultaneously. Finally, the combined data query response 455 can be sent to the querying system 460 for example, for further analysis, use, or display to a user.

IV.A. Resampling Continuous and Unit Data

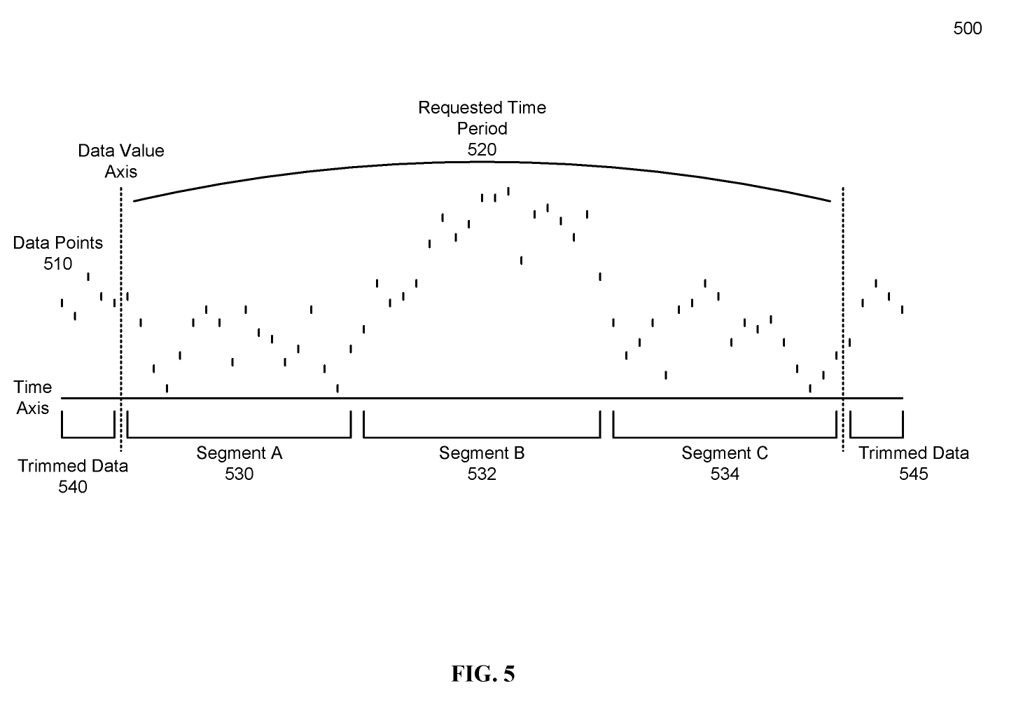

FIG. 5 illustrates an example process for resampling continuous data. The environment 500 of FIG. 5 shows a series of continuous data points 510 (from the same or different blocks of the long term storage, for example) overlapping a requested time period 520. In this embodiment, the requested time period 520 is being resampled into three segments 530-534, each of which will correspond to a different resampled data point associated with resampled values calculated based on the original data points in that segment. For example, each segment can correspond to a specific range of time based on the desired resampled resolution/frequency. In FIG. 5, the data points are arranged along a data value axis (for example, temperature as measured by a temperature sensor) and a time axis. In this embodiment, the data points 510 extend beyond the requested time period 520 and the excess trimmed data 540 and 545 may not be reflected in the resampled data. In some implementations, data points can be retrieved from a database or file storage system (such as the initial database 110 or the long term database 120) in the form of an ordered data stream (for example, ordered by timestamp), enabling resampling operations to be carried out on the retrieved data points without the need to store the entire series of data points in memory concurrently.

In this example, the continuous data points 510 are being resampled to a lower sampling frequency over the requested time period 520. The data points 510 represent continuous data and are sampled at a constant (or substantially constant) sample rate, according to this embodiment. To resample the data points 510, the requested time period 520 is split into a series of segments 530-534 based on the desired resolution of the sampled data and/or the number of data points in the requested time period 520. Each segment can be associated with a single resampled data point. Segments can be generated based on an even division of the request time period 520, based on achieving a (roughly) even division of the data points 510 within the requested time period 520, or by any other suitable method. For example, each segment 530-534 can be assigned a set number of data points from the requested time period 520. When the data points 510 are not be evenly divisible into the appropriate number segments the data points 510 are divided among the segments to achieve a roughly even division of the data points (for example, by minimizing the discrepancies between the number of data points associated with each segment.

In the example of FIG. 5, the data points 510 are ingested in order from a data stream. First, any excess data points 510 before the start of the requested time period (range) 520 can be trimmed 540 from the data stream. Resampled values for each segment 530-534 can then be determined based on the data stream of continuous data points 510. The data points 510 can be consumed from the data stream and stored in memory sequentially or in chunks corresponding to each segment 530-534. In some implementations, calculations are performed to generate the resampled values for a segment 530-534 before the data points 510 associated with the next segment 530-534 are loaded into memory. In some embodiments, resampled values (such as the average or median of the data points associated with the segment) for a segment 530-534 are calculated as each data point 510 is assigned to the segment, but the resampled values for a segment can also be calculated after all data points 510 for the segment are loaded into memory (for example, from a data stream). The calculated resampled values for the segment are then associated with the appropriate resampled data point and the data points 510 associated with the segment 530-534 can be cleared from memory to free memory space for computation of resampled values for the next segment 530-534, according to some embodiments. As described above, resampled values can include minimum and maximum values in the segment, an average or median of the segment, a number of data points associated with the segment, or any other suitable statistics about the segment. After resampled values for each segment 530-534 are calculated, any remaining data points 510 outside the requested time period 520 are discarded. This method of resampling can be advantageous because the full set of data points 510 is not required to be kept in memory at the same time, as resampling calculations occur on a per-segment basis.

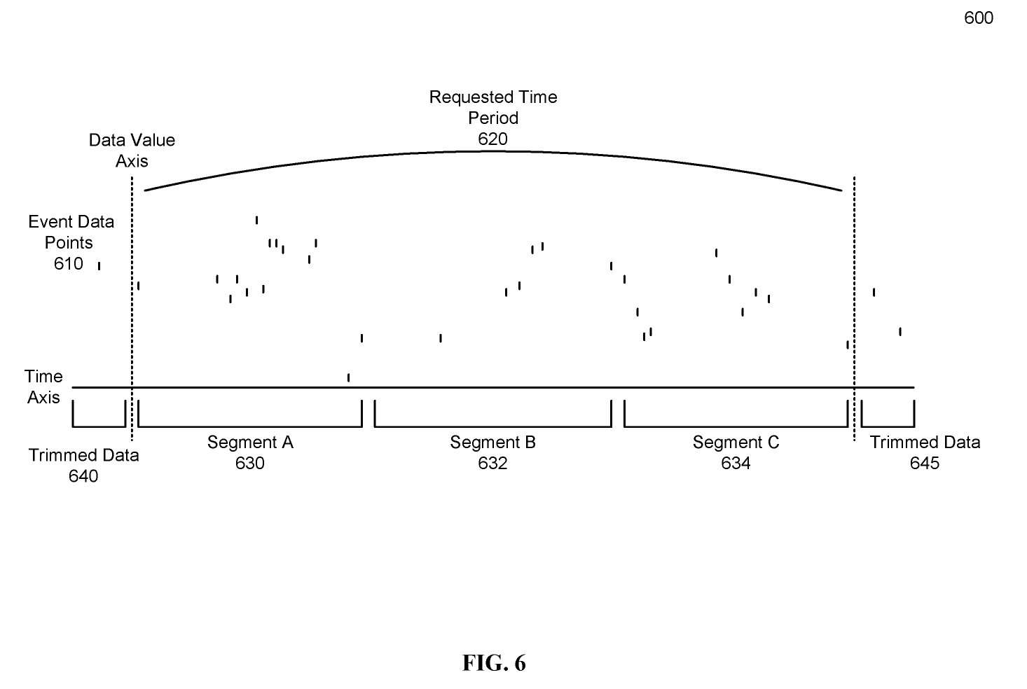

FIG. 6 illustrates an example process for resampling a unit data set. The environment 600 of FIG. 6 shows a set of event data points 610 overlapping a requested time period 620. The requested time period 620 of this embodiment is being resampled into three segments 630-634. The event data points 610 of FIG. 6 represent unit data, where each event data point 610 is associated with a timestamp associated with, for example, the time at which an event was detected. In this embodiment, the data points 610 extend beyond the requested time period 620 and the excess trimmed data 640 and 645 may be discarded in the process of resampling and not reflected in the resampled data. Similar to FIG. 5, the data points 610 of FIG. 10 are arranged along a data value axis and a time axis. In some implementations, a data stream of the event data points 620 is used for resampling operations to be carried out on the event data points 610 without the need to store the entire series of event data points 610 in memory concurrently.

In the embodiment of FIG. 6, the event data points 610 are being resampled to a specific display resolution over the requested time period 620. In this embodiment, each of the event data points 610 represents an event recorded a specific point in time. To resample the event data points 610, the requested time period 620 is split into a series of segments 630-634 based on the desired resolution of the resampled data. Each segment 630-634 can be associated with a single resampled data point which will be delivered to a querying device 160. In the case of unit data, such as the event data points 610, segments can be generated based on an even division of the request time period 620. For example, each segment 630-634 can be assigned a specific time range of the requested time period 620. In contrast to the continuous data points 510 of FIG. 5, the event data points 610 do not necessarily occur at regular time intervals, and therefore the number of event data points 610 associated with each of the segments 630-634 may not be consistent.

According to some embodiments, the event data points 610 are ingested in order from a data stream. First, any excess data points 610 before the start of the requested time period 620 are trimmed 640 from the data stream and disregarded. Then, resampled values for each segment 630-634 can be calculated based on the event data points 610. The event data points 610 can be consumed from the data stream and stored in memory sequentially or in chunks corresponding to each segment 630-634. The resampled values for a segment 630-634 can be calculated as the data points 610 associated with that segment are loaded into memory from the data stream. The calculated resampled values can then be associated with the appropriate resampled data point and the process can move on to the next segment 630-634. The calculated resampled values for the segment 630-634 are then stored and the event data points 610 associated with the segment 630-634 can be cleared from memory to free memory space for further computation of resampled values, according to some embodiments. To represent unit data, resampled values can include a number of event data points 610 occurring within in the segment 630-634, a median or average time of the associated event data points 610, or any other suitable statistics about the event data points 610 associated with the segment. After the resampled values for each segment 630-634 are calculated, any remaining data points 610 outside the requested time period 620 (in this example the trimmed data 645) can be discarded.

IV.B. Example Query Response Interaction Diagram

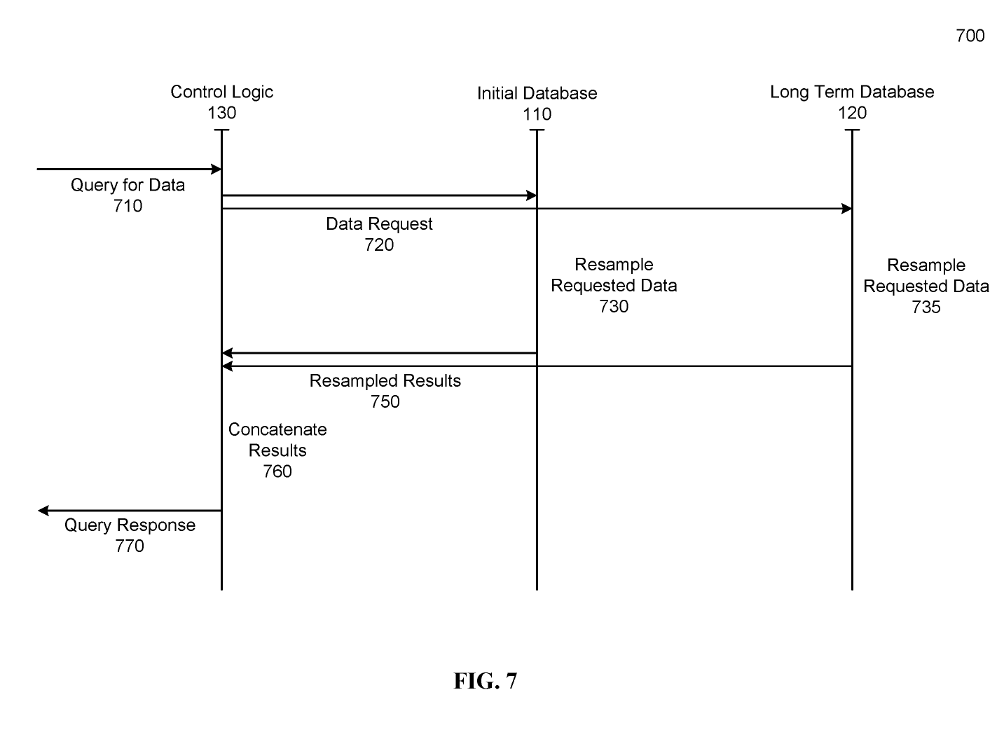

FIG. 7 is an interaction diagram illustrating an example process for responding to a received query for data. The process 700 begins when a query for data 710 is received at the control logic 130. After processing the query, the control logic 130 separately sends a data request 720 to each of the initial database 110 and the long term database 120. In this embodiment, the initial 110 and long term databases each process the respective data request 720 and independently retrieve and resample the requested data 730 and 735. The resampled results 750 from the initial 110 and long term 120 are then separately returned to the control logic 130. The control logic 130 can then concatenate 160 the received results and send the appropriate query response 770.

### V. Implementation Examples

V.A. Example Initial Database Table Structure

In some embodiments, Hbase is used for the initial database 110 as a high-throughput, highly available time series database. Hbase is a scalable, columnar key value store. In one implementation of an initial database using Hbase, one table is used: “ts” for timeseries. There is one column family inside the table named “t” for timeseries. Here, the channel ID is a device identifier for a reporting device or a specific identifier of a particular sensor on the reporting device. An example may be a unique media access control (MAC) address, but other types of IDs are possible.

Table: “ts” [

Rowkey: “channelID:timestamp” => [
Column Family: ”t” =>

data (e.g., sensor) value (8 bytes) representing one double

precision floating point value

]

]

Based on the table structure outlined above, a data entry may have a rowkey such as “c507efb3-8c3a . . . :149573838011500,” where the “c507efb3-8c3a . . . ” section of the rowkey is the channel ID associated with the data entry and the “149573838011500” portion of the rowkey is the timestamp of the data entry (here represented in 149573838011500 microseconds since Jan. 1, 1970). For example, the initial database may contain the following information.

TABLE 1

| Rowkey (in the format channelID:timestamp) | Sensor Value |
|---|---|
| c507efb3-8c3a . . . :149573838011500 | −2099.85975426435 |
| c507efb3-8c3a . . . :149573838013500 | −2098.5305608511 |
| c507efb3-8c3a . . . :149573838015500 | −2091.61875510216 |
| c507efb3-8c3a . . . :149573838017500 | −2090.8212390542 |
| c507efb3-8c3a . . . :149573838019500 | −2100.12559294701 |

V.B. Example Initial Database Write Request

An example write request to an initial database 110 implemented using Hbase may include the following information.
DateTime=May 25, 2017 18:52:34 GMT=149573838011500 microseconds since Jan. 1, 1970
DateTime as bytes (octal representation): 42 00 45 37 36 67 61 54
Channel ID=N:channel:c507efb3-8c3a-41b5-b4e8-579c6e468788
Row_key=channel+datetime
Sensor value=0.51234238 represented as a double precision floating point value
val params: BufferedMutatorParams=new BufferedMutatorParams(“ts”)
val mutator: BufferedMutator=connection.getBufferedMutator(params)
val put=new Put(makeRowKey(dp))
val value=Bytes. toBytes (dp.value)
put.addColumn(“t”, “t”, value)
bufmut.mutate(put)

V.C. Reading Time Series Data from Initial Database

In some embodiments, reading from an initial database 110 implemented using Hbase entails scanning the table by specifying at least a start key and optionally, an end key. For example, if the querying system 160 wishes to request the start of the range of a specific channel, the start key can be the channel ID with the timestamp omitted. Otherwise, the start key can be the channel ID of the desired channel concatenated with the desired start time of the read, as shown above for writing data. For example, a startkey of “c507efb3-8c3a . . . :149573838011500,” may indicate a desired channel ID of “c507efb3-8c3a . . . ” beginning with the data timestamped “149573838011500.” Similarly, a read request can specify limits on the number of rows (datapoints) that will be returned, or specify an endkey. The initial database 110 can then return an iterator that allows retrieval of each of the values for the desired column family (“t”).

V.D. Example Long Term Database Storage Index Table Structure

A storage index 124 can be implemented using a PostgreSQL database configured to index the files in the file storage 122 with the timestamp range and channel IDs of the data contained within those files. An example PostgreSQL table may be defined as follows.

CREATE TABLE ranges (

id integer NOT NULL, --primary key
channel character varying NOT NULL, --channel identifier
rate double precision NOT NULL, --sampling rate
range int8range, -start and end range in UNIX epoch microseconds
location character varying, --url of file in the cloudfront CDN
Follows_gap boolean NOT NULL --reserved

);

V.E. Time Series Ranges Table

To insert an entry about a file or data block into a storage index 124 can specify the file name/identifier, any associated channel IDs, the sampling rate of the captured data, and any other suitable information. An example request to insert information about a file into the storage

index 124 can be defined as follows.
insert into timeseries.ranges
(channel,rate,range,location,follows_gap) values
(‘chan1’, 250.0, int8range(149573818011500,149573838011500),
‘http://X.io/test.btfs.gz’, false)

V.F. Raw File Storage Time Series File Layout

In some implementations the file storage 122 can be implemented using a file storage system implemented using Amazon's S3. In the implementations the individual binary assets representing the actual data values can be simple raw binary files. The data can be stored in raw binary files, where every 8 bytes represent a single time & data point. The data storage infrastructure 105 can make the assumption that each asset represents a contiguous period of time, and that the sample rate stays constant for the entire period, as expressed in the range table. In other instances, the range table may indicate that the data stored in the file is unit data and a different file structure may be used.

The file is then compressed using a compression utility, an example of which is GZIP. This has the advantage that when the files are requested, better throughput and transparent decompression is achieved. A further advantage of this simple, regular format is that the data can be consumed and sampled incrementally, which is fast, performant, and keeps memory overhead very low.

### VI. Additional Considerations

It is to be understood that the figures and descriptions of the present disclosure have been simplified to illustrate elements that are relevant for a clear understanding of the present disclosure, while eliminating, for the purpose of clarity, many other elements found in a typical system. Those of ordinary skill in the art may recognize that other elements and/or steps are desirable and/or required in implementing the present disclosure. However, because such elements and steps are well known in the art, and because they do not facilitate a better understanding of the present disclosure, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope of the inventive ideas described herein.

What is claimed is:

1. A data storage infrastructure comprising:
a first database storing a plurality of data entries, each data entry including:
a key comprising a channel identifier of a reporting device and a timestamp associated with sensor data reported for that timestamp; and
a value of the sensor data reported by the reporting device;
a second database comprising:
a file storage database comprising a plurality of files, each file comprising a plurality of data entries, each data entry comprising a channel identifier of a reporting device, a timestamp, and sensor data reported by the reporting device;
a storage index comprising a table having a plurality of rows and columns including:
a channel identifier column indicating the channel identifier for each row;
a time range column indicating a range of timestamps associated with each row;
an address column indicating an address of a file in the file storage database associated with each row; and
wherein each entry in the storage index relates to one of the files in the file storage database; and
a control logic layer configured to:
select a subset of data entries of the first database;
create a row in the storage index and a file in the file storage database corresponding to the subset of data entries; and
remove the subset of data entries from the first database.

2. The data storage infrastructure of claim 1, wherein the first database is a time series database configured to order received data entries.

3. The data storage infrastructure of claim 1, wherein selecting a subset of data entries of the first database comprises:
selecting a data block associated with a timestamp range, the data block comprising the subset of data entries, wherein each data entry is associated with a timestamp in the timestamp range.

4. The data storage infrastructure of claim 3, wherein selecting the data block comprises determining if the data block is complete based on a threshold time from the timestamp range associated with the data block.

5. The data storage infrastructure of claim 3, wherein the created file in the file storage database comprises the subset of data entries and the created row in the storage index comprises a timestamp range of the data block and location of the data block within the file storage database.

6. The data storage infrastructure of claim 1, wherein the control logic layer is further configured to:
receive, from a requesting device, a request for data entries associated with a requested timestamp range;
request data entries within the requested timestamp range from the first database;
retrieving a data block associated with the requested timestamp range from the second database;
combining the retrieved data entries from the first and second databases into a requested subset of data entries; and
returning the requested subset of data entries to the requesting device.

7. The data storage infrastructure of claim 6, wherein combining the retrieved data entries from the first and second databases comprises resampling the retrieved data entries to a target sampling frequency.

8. A method comprising:
receiving, at a data storage infrastructure from a reporting device, a data stream comprising a plurality of data entries, each data entry including:
a channel identifier;
a timestamp; and
sensor data associated with the timestamp; and
wherein the plurality of data entries are received out of timestamp order;
storing, in a first database, the plurality of data entries as they are received at the data storage infrastructure, wherein storing the plurality of data entries in the first database comprises ordering the plurality of data entries;
selecting, from the stored plurality of data entries in the first database, a data block comprising a first subset of data entries associated with a range of timestamps;
storing, in a file storage database, a file comprising the data block;
generating, in a storage index of the second database, an index entry describing the data entries of the data block, the index entry indicating a channel identifier associated with the data block, a range of timestamps associated with the data block, and an address of the data block within the file storage database; and
deleting, from the first database, the first subset of data entries corresponding to the data block.

9. The method of claim 8, wherein the first database is a time series database comprising a key value structure.

10. The method of claim 9, wherein the row key for each data entry of the first database comprises the timestamp of the data entry and a channel identifier.

11. The method of claim 8, wherein selecting a data block comprising a first subset of data entries associated with a range of timestamps comprises determining if the data block is complete based on a threshold time from the timestamp range associated with the data block.

12. The method of claim 8, further comprising:
receiving, from a requesting device, a request for data entries associated with a requested timestamp range;
retrieving, from the first and second databases, data entries within the requested timestamp range;
combining the retrieved data entries from the first and second databases into a requested subset of data entries; and
returning the requested subset of data entries to the requesting device.

13. The method of claim 12, wherein retrieving, from the first and second databases, data entries within the requested timestamp range further comprises:
querying the storage index for a requested data block associated with the requested timestamp range;
retrieving, from the file storage database, the requested data block associated with the requested timestamp range; and
selecting from the requested data block, one or more data entries associated with the requested timestamp range.

14. The method of claim 12, wherein combining the retrieved data entries from the first and second databases comprises resampling the retrieved data entries to a target sampling frequency.

15. A non-transitory computer readable storage medium comprising instructions which, when executed by a processor, cause the processor to perform steps comprising:
receiving, at a data storage infrastructure from a reporting device, a data stream comprising a plurality of data entries, each data entry including:
a channel identifier;
a timestamp; and
sensor data associated with the timestamp; and
wherein the plurality of data entries are received out of timestamp order;
storing, in a first database, the plurality of data entries as they are received at the data storage infrastructure, wherein storing the plurality of data entries in the first database comprises ordering the plurality of data entries;
selecting, from the stored plurality of data entries in the first database, a data block comprising a first subset of data entries associated with a range of timestamps;
storing, in a file storage database, a file comprising the data block;
generating, in a storage index of the second database, an index entry describing the data entries of the data block, the index entry indicating a channel identifier associated with the data block, a range of timestamps associated with the data block, and an address of the data block within the file storage database; and
deleting, from the first database, the first subset of data entries corresponding to the data block.

16. The computer readable storage medium of claim 15, wherein the first database is a time series database comprising a key value structure.

17. The computer readable storage medium of claim 15, wherein selecting a data block comprising a first subset of data entries associated with a range of timestamps comprises determining if the data block is complete based on a threshold time from the timestamp range associated with the data block.

18. The computer readable storage medium of claim 15, further comprising:
receiving, from a requesting device, a request for data entries associated with a requested timestamp range;
retrieving, from the first and second databases, data entries within the requested timestamp range;
combining the retrieved data entries from the first and second databases into a requested subset of data entries; and
returning the requested subset of data entries to the requesting device.

19. The computer readable storage medium of claim 18, wherein retrieving, from the first and second databases, data entries within the requested timestamp range further comprises:
querying the storage index for a requested data block associated with the requested timestamp range;
retrieving, from the file storage database, the requested data block associated with the requested timestamp range; and
selecting from the requested data block, one or more data entries associated with the requested timestamp range.

20. The computer readable storage medium of claim 18, wherein combining the retrieved data entries from the first and second databases comprises resampling the retrieved data entries to a target sampling frequency.

21. A system comprising:
a data storage infrastructure configured to:
receive, from a reporting device, a data stream comprising a plurality of data entries, each data entry including:
a channel identifier;
a timestamp; and
sensor data associated with the timestamp; and
wherein the plurality of data entries are received out of timestamp order;
wherein the data storage infrastructure comprises a first database configured to:
store the plurality of data entries as they are received at the data storage infrastructure, wherein storing the plurality of data entries in the first database comprises ordering the plurality of data entries;
wherein the data storage infrastructure is further configured to:
select, from the stored plurality of data entries in the first database, a data block comprising a first subset of data entries associated with a range of timestamps;
store, in a file storage database of the data storage infrastructure, a file comprising the data block;
generate, in a storage index of the data storage infrastructure, an index entry describing the data entries of the data block, the index entry indicating a channel identifier associated with the data block, a range of timestamps associated with the data block, and an address of the data block within the file storage database; and
delete, from the first database, the first subset of data entries corresponding to the data block.
